(19) United States
(12) Patent Application Publication
(10) Pub. No.: US 2021/0180503 A1
(43) Pub. Date: Jun. 17, 2021

(54) THIN WALLED WELDED CONNECTION

(71) Applicant: Flexible Metal, Inc., Hamburg, MI (US)

(72) Inventors: Michael Goodrich, Hamburg, MI (US); Michael Nicholson, Hamburg, MI (US)

(73) Assignee: Flexible Metal, Inc., Hamburg, MI (US)

(21) Appl. No.: 16/713,647

(22) Filed: Dec. 13, 2019

(51) Int. Cl. F01N 13/18; F16L 11/15

(52) U.S. Cl. CPC F01N 13/1805; F16L 33/26; F16L 11/15

(57) ABSTRACT

A method of attaching a casted metal part and a metal hose line includes: providing a cast metal part having a cylindrical portion; providing a metal hose line; heating the metal hose line to a temperature of between 500 and 900 degrees Fahrenheit; positioning the inner diameter of the metal hose line over the outer diameter of the cylindrical portion; allowing the metal hose line to cool to reduce the gap between the inner diameter of the metal hose line and the outer diameter of the cast metal part; and forming a first weld along an outer circumference of the metal hose line, wherein the width of the first weld at the connection between the hose line and cast metal part is 50% or less than the metal hose wall thickness.

### FIELD OF INVENTION

The present invention relates to an connection design and method for connecting a thin-walled hose or piping to an attachment part, such as a casted or metal formed part.

### BACKGROUND

Motor vehicle with internal combustion engines commonly use hoses and pipes to export exhaust gasses from the exhaust manifold of an engine. Those hoses commonly include metal bellows, such as at or near connection points, to absorb and reduce vibrations, improve installation, and compensate for thermal growth. In some cases the bellows are connected to hose lines via a threaded connection or using V-clamps or other attachment methods. Alternatively, plug-in connections or FEY-ring connections can be used at the connection.

These types of connections have numerous disadvantages. For example, these types of connections fail to maintain their seal over time and are highly susceptible to leaking in the attachment region.

In addition, known attachment methods require a relatively large installation space in the axial direction, which has a disadvantageous effect on the flexibility to be achieved in the hose line to be used. In particular, if this is formed as a bellows, then the installation space required for the attachment connection limits the number of possible bellows corrugations at the top. Associated with this are relatively high wear and a correspondingly short service life of the known attachment connections.

In some cases, a welded connection is used to secure a bellows to the casted manifold. However, such welded connection methods commonly require a weld bond cross-section that is fairly large with respect to the wall of the bellows. This type of weld has numerous disadvantages, including a high probability that the weld is impacted by casting porosity, and a potential for larger weld spatter.

For at least these reasons, an improved connection method is needed.

### SUMMARY

An attachment connection between a first metal part and a second metal part is generally presented. The first metal part may be a cast metal part having a generally cylindrical portion. The second metal part may be a metal hose line having a generally cylindrical portion positioned about the generally cylindrical portion of the first metal part. The first and second metal parts may be joined by one or more weld connections between them. The weld connections may each comprise a weld seam having a thickness at the connection between the first and second metal parts that is less than 50% of the wall thickness of the second metal part.

In an embodiment, the welds are formed by laser welds, such as one, two or three adjacent laser welds, or more. The first part may comprise a cast exhaust manifold and the second part may comprise a metal bellows. Each of the weld seams may have a thickness at the connection between the first and second metal parts that is at least 0.3 times the wall thickness of the second metal part.

In an embodiment, a method of attaching a casted metal part having a generally cylindrical portion and a metal hose line having a wall thickness is presented. The method comprises the steps of: providing a cast metal part having a cylindrical portion having an outer diameter; providing a metal hose line having an inner diameter and a wall thickness; heating the metal hose line to a temperature of between 500 and 900 degrees Fahrenheit; positioning the inner diameter of the metal hose line over the outer diameter of the cylindrical portion; allowing the metal hose line to cool to reduce the gap between the inner diameter of the metal hose line and the outer diameter of the cast metal part; and forming a first weld along an outer circumference of the metal hose line, wherein the width of the first weld at the connection between the hose line and cast metal part is 50% or less than the metal hose wall thickness.

In an embodiment, the method of attaching the cast metal part and the hose line includes the step of forming a second weld along an outer circumference of the metal hose line, adjacent to the first weld, wherein the width of the second weld at the connection between the hose line 12 and cast metal part is 50% or less than the metal hose wall thickness.

### BRIEF DESCRIPTION OF THE DRAWINGS

The operation of the invention may be better understood by reference to the detailed description taken in connection with the following illustrations, wherein:

FIG. 1 illustrates a side view of an attachment connection between a bellows and a cast engine manifold;

FIG. 2 illustrates a side view of an attachment connection between a bellows and a cast engine manifold;

FIG. 3 illustrates a cutaway view of three weld connections connecting a metal hose line to a cast metal part;

FIG. 4 illustrates a cutaway view of three weld connections connecting a metal hose line to a cast metal part with positioning annotations;

FIG. 5 illustrates a cutaway view of a single weld connection connecting a metal hose line to a cast metal part;

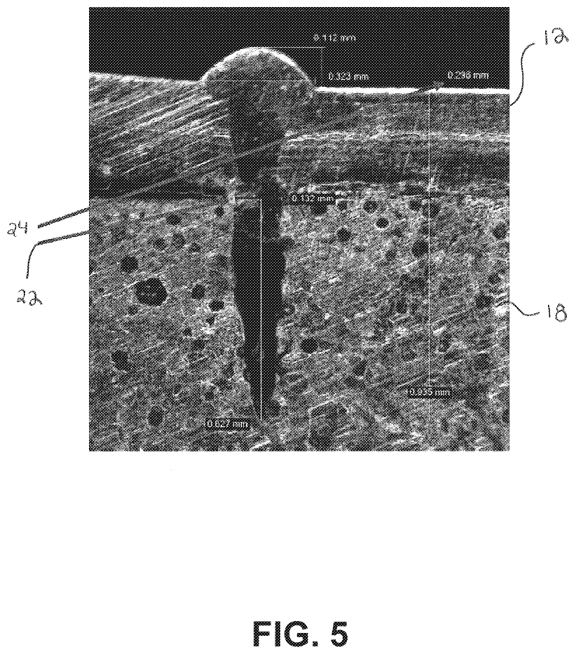

FIG. 6 illustrates a perspective view of a connection between a bellows and a cast metal part; and

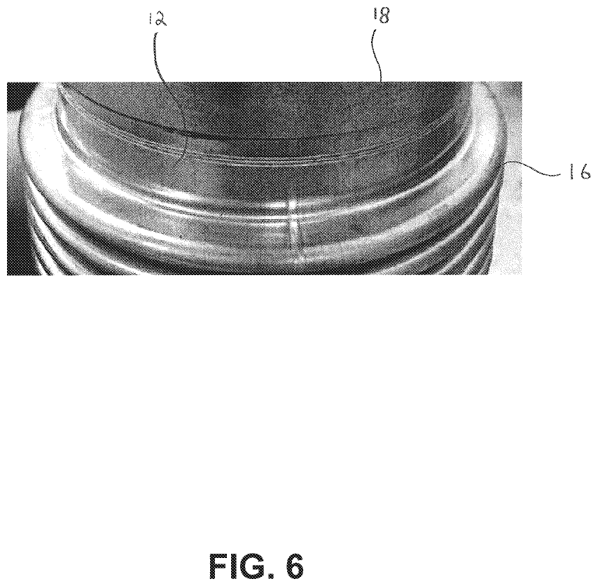

FIG. 7 illustrates a metal hose to cast metal part connection having reduced size weld spatter.

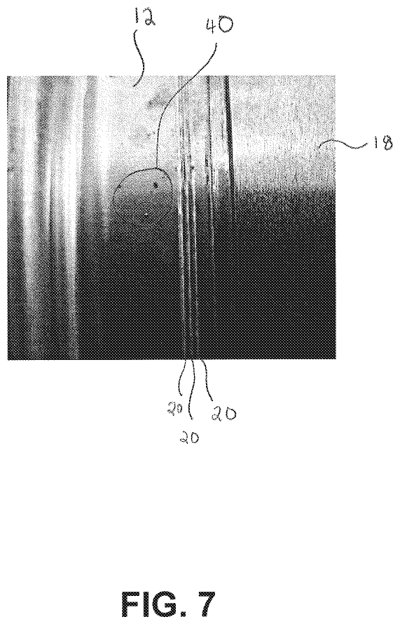

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

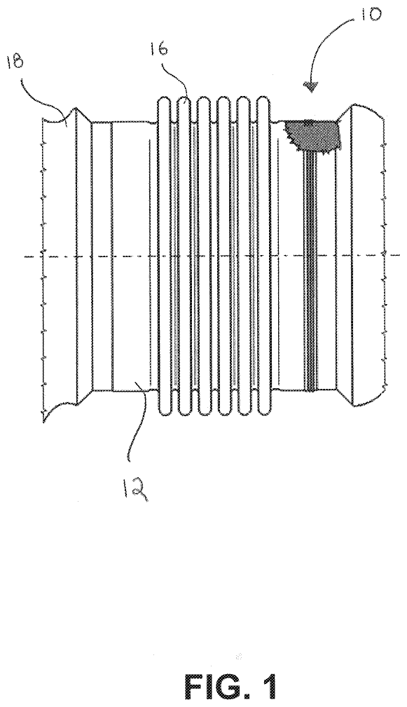

FIG. 1 illustrates an attachment connection 10 between a thin-walled hose line 12 and a casted part 18. The hose line 12 may be any appropriate metal hose or piping, such as a metal bellows having a corrugated section 16. The welded attachment described herein may be made along the non-corrugated portion of the bellows. The casted part 18 may comprise a portion of an engine manifold 18 formed of cast iron, or any appropriately casted material.

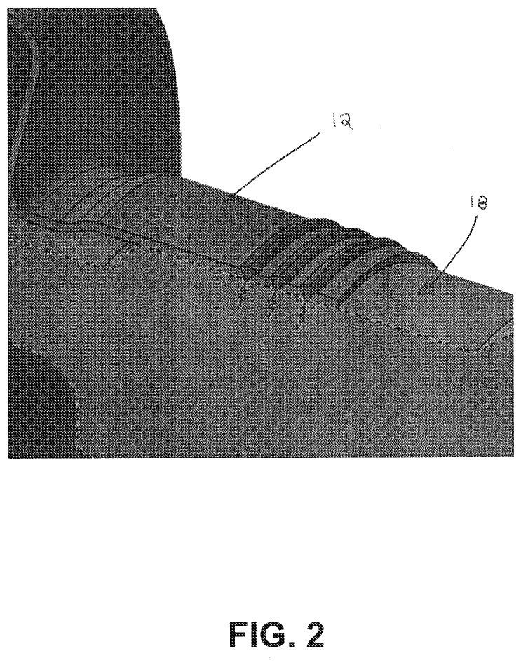

The hose line 12 may comprise a thin walled metallic ring, such as a cylindrical portion, that is configured to engage the casted portion of the manifold 18. As illustrated in FIGS. 1 and 2, a cylindrical portion of the hose line 12 having an inner diameter is positioned over and around a cylindrical portion of the casted manifold 18 having an outer diameter. The inner diameter of the hose line 12 may be very slightly larger than the outer diameter of the manifold 18 to minimize the gap between them. This gap may be further reduced by the process discussed in further detail below.

While the present configuration is shown in drawings and described herein as a connection between a bellows hose line 12 and an exhaust manifold 18, it will be appreciated, that the connections and method of connection set forth herein may be any connection between any metal hose line and any other metal or casted.

Traditional attachment solutions employ a weld seam that is comparably thick when compared to the thickness of the hose line wall. For example, some solutions utilize a weld that has a width that is more than half the thickness of the of the hose line 12. However, these larger welds have a greater impact from casting porosity on the weld quality, which may lead to holes in the weld. The larger welds also suffer from larger weld spatter that can potentially cause stress risers in the bellows and lead to cracking.

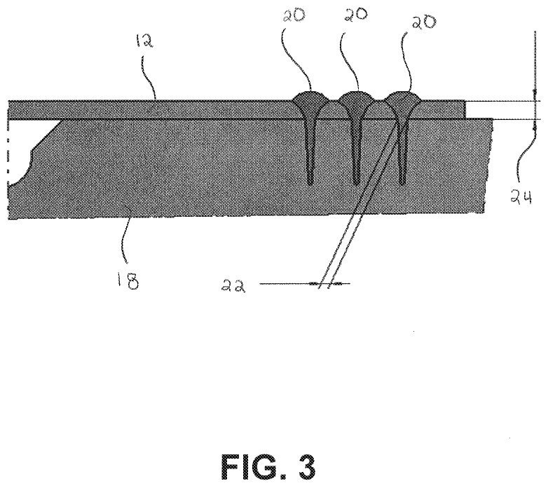

To avoid these drawbacks, a weld seam 20 having reduced thickness, such as a laser weld, may be used to connect the hose line 12 and an exhaust manifold 18. With reference to FIG. 3, the thickness 22 of the weld seam 20 may be measured as the width of the weld 20 at the plane where the hose line 12 and manifold 18 meet. The weld thickness 22 may be limited to be less than 50% of the thickness 24 of the hose line 12. As shown in FIG. 3, the thickness 24 of the hose line 12 may be measured at the area of the hose line 12 adjacent to the weld 20.

To create a weld seam 20 having the reduced thickness described above, a laser weld may be used. However, it will be appreciated that any known welding techniques may be used to create the weld 20 having a thickness 22 that is less than 50% of the thickness 24 of the hose line 12.

In an embodiment, the weld thickness 22 may be limited to between 0.3 and 0.5 times the thickness 24 of the hose line 12.

In an embodiment, the connection between the hose line 12 and the exhaust manifold 18 may comprise a plurality of welds 20, such as three adjacent welds. Each of the three welds 20 may have a thickness 22 that is less than 50% of the thickness 24 of the hose line 12 at each respective weld location.

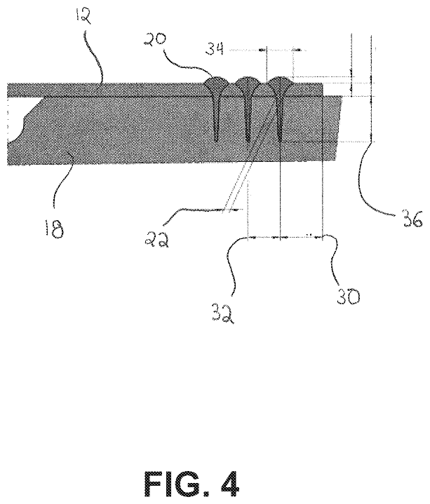

In an embodiment illustrated in FIG. 4, the plurality of welds 20 may be positioned to optimize the connection and weld spacing. To do this, various parameters of the weld spacing and size, as illustrated in FIG. 4, may be controlled to optimize performance and longevity of the connection, as set forth below.

In an embodiment, the weld seam center line position 30 may be measured from an end of the hose line 12 to the center of the weld. The weld seam center line position 30 of the weld closest to the edge of the hose line 12 may be maintained between 2 mm and 8 mm from the hose line edge.

In an embodiment, the space 32 between the weld seams 20, when a plurality of weld seams 20 are used, is defined as the space between the center of adjacent weld seams 20. The space 32 between adjacent weld seams 20 may be limited to between 0.5 mm and 1.5 mm.

In an embodiment, the width 34 of the weld seam 20 at the surface of the hose line 12 may be limited to between one times and three times the thickness 24 of the hose line 12.

In an embodiment, the weld seam depth 36 may be defined as the width that the weld seam 20 extends into the casted manifold 18. The weld seam depth 36 may be limited to between two times and five times the thickness 24 of the hose line 12.

The weld connection as set forth above may yield numerous benefits over wider/thicker welds. First the smaller/thinner weld described herein yields less impact from casting porosity on weld quality. This reduces the potential for holes or gaps within the weld seam 20. Second, the smaller weld yields smaller weld spatter 40, as shown in FIG. Weld spatter that lands on the hose line 12 has a potential to cause stress risers that may result in cracks at the spatter location, thus compromising the seal. Third, use of two or more welds provides for the addition of an extra seal between the hose line 12 and the manifold 18. If a first weld leaks between the hose line 12 and the casting material 18, the second or third weld may still provide the missing seal to ensure a leak tight joint.

In an embodiment a method or process of attaching and welding a hose line 12, such as a bellows, to a manifold 18 is provided. The process is configured to minimize the gap between the hose line 12 and the manifold 18. Minimizing the gap is critical to achieving a reliable weld attachment.

The method of attachment includes machining a neck or cylindrical portion of a casting to a specific size. The casting neck size may be regulated within given tolerances. A hose line 12 or bellows may be formed, such as hydroformed, to have an inner radius approximately equal to or slightly less than the outer radius of a casting neck of the manifold 18. Prior to connecting the bellows to the casting neck, the bellows may be heated to a temperature of approximately 500 to 900° F. Heating the bellows increases the diameter of the bellows due to thermal expansion. The heated bellows is fit over the casted machine neck while in expanded form. The bellows is then allowed to cool and shrink back to original size. This shrinking creates a press for intimate zero gap fit with the casting. The zero gap fit is critical to achieving a successful laser weld.

Once the hose line 12 or bellows and manifold casting neck are attached, the connection may be welded to provide a seal and prevent leaking of exhaust gasses. In an embodiment, as described above, one or more laser welds 20 may be applied around the outer radius of the hose line 12. The laser welds 20 may begin approximately 2.5 to 3.5 millimeters from an edge of the hose line 12. The welds 20 may each have a thickness at the connection between the first and second metal parts that is less than 50% of the wall thickness of the second metal part

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. An attachment connection comprising:
a first metal part having a generally cylindrical portion, wherein the first metal part is a casted metal part;
a second metal part having a generally cylindrical portion positioned about the generally cylindrical portion of the first metal part, wherein the second metal part is a hose line having a wall thickness;
one or more weld connections between the first metal part and the second metal part, wherein the weld connections each comprise a weld seam having a thickness at the connection between the first and second metal parts that is less than 50% of the wall thickness of the second metal part.

2. The attachment connection of claim 1, wherein the first metal part is a cast iron exhaust manifold.

3. The attachment connection of claim 1, wherein the second metal part comprises a bellows.

4. The attachment connection of claim 1, wherein the weld seam has a thickness at the connection between the first and second metal parts that is at least 0.3 times the wall thickness of the second metal part.

5. The attachment connection of claim 1 comprising three weld connections arranged adjacent to one another and spaced away from an edge of the second metal part.

6. The attachment connection of claim 5 wherein the first weld seam is located between 2.5 and 3.5 millimeters away from an edge of the second metal part.

7. The attachment connection of claim 1, wherein the weld connections are laser weld connections.

8. A method of attaching a casted metal part having a generally cylindrical portion and a metal hose line having a wall thickness, the method comprising:
providing a cast metal part having a cylindrical portion having an outer diameter;
providing a metal hose line having an inner diameter and a wall thickness;
heating the metal hose line to a temperature of between 500 and 900 degrees Fahrenheit;
positioning the inner diameter of the metal hose line over the outer diameter of the cylindrical portion;
allowing the metal hose line to cool to reduce the gap between the inner diameter of the metal hose line and the outer diameter of the cast metal part;
forming a first weld along an outer circumference of the metal hose line, wherein the width of the first weld at the connection between the hose line and cast metal part is 50% or less than the metal hose wall thickness.

9. The method of claim 8, further comprising the step of forming a second weld along an outer circumference of the metal hose line, adjacent to the first weld, wherein the width of the second weld at the connection between the hose line 12 and cast metal part is 50% or less than the metal hose wall thickness.

10. The method of claim 8, wherein the cast metal part is a cast iron exhaust manifold.

11. The method of claim 8, wherein the metal hose line comprises a bellows.

12. The method of claim 8, wherein the weld has a thickness at the connection between at the connection between the hose line and cast metal part of at least 0.3 times the wall thickness of the metal hose line.

13. The method of claim 8, wherein the first weld is located between 2.5 and 3.5 millimeters away from an edge of the metal hose line.

14. The attachment connection of claim 1, wherein the weld is formed by a laser welding process.
